(19) United States
(12) Patent Application Publication
(10) Pub. No.: US 2026/0228727 A1
(43) Pub. Date: Aug. 6, 2026

(54) PREDICTIVE MODEL LEVERAGING GENERATIVE AI-BASED RETRIEVAL AUGMENTED FINE-TUNING AUTHENTICATION - ENHANCED AUTHENTICATION FOR INTERNATIONAL BANKING TRANSACTIONS

(71) Applicant: Bank of America Corporation, Charlotte, NC (US)

(72) Inventors: Saurabh Garg, Haryana (IN); Subburathinam Krishnan, Tamil Nadu (IN); M Jayasri, Chennai (IN); Bharathi Kathiravan, Tamil Nadu Chennai (IN); Sumathi Ganapathi, Tamil Nadu (IN); Alamelu Kalairjan, Tamil Nadu (IN); Saurabh Gupta, New Delhi (IN)

(21) Appl. No.: 19/044,748

(22) Filed: Feb. 4, 2025

(51) Int. Cl. G06Q 20/40; G06Q 20/38

(52) U.S. Cl. CPC G06Q 20/401; G06Q 20/389

(57) ABSTRACT

An authentication system and method may use a generative AI (Gen AI) engine to automatically select one of multiple user electronic devices and which authentication method to use to authenticate a user and authorize an electronic transaction. The transaction may be an international transaction between a user and a third party that may be performed online. The system and method may leverage Gen AI-based Retrieval-augmented Fine-Tuning Authentication (RAFTA) technology to generate a personalized user pathway to authentication. A RAFTA Gen AI engine may use a combination of a retrieval-augmented based model with fine-tuning to optimize authentication processes and enhance security. The retrieval augmentation may include retrieval of transaction histories, security protocols, and user interaction patterns. The RAFTA Gen AI engine may analyze parameters, such as the user's location, available network connectivity options, or available electronic devices at the user's disposal, to select the electronic device and authentication method.

### FIELD OF THE DISCLOSURE

Aspects of the disclosure relate to creating a customized pathway for a user to be authenticated to conduct an international banking transaction.

### BACKGROUND OF THE DISCLOSURE

Many online transactions require a robust authentication mechanism to verify an identity of a user. Traditional authentication methods may fail to adapt to the dynamic nature of some online transactions, especially those occurring across borders. Certain international transactions may lack the ability to implement adequate electronic authentication protocols, at least because certain technology may not work across borders. For example, a robust authentication mechanism such as OTP (One Time Password) generation may not work because passwords may not be able to be transmitted by text or otherwise from one country to another.

Without a robust authentication mechanism, there is a significant security gap in electronic (digital) authentication systems. Both institutions and users who may engage in cross-border transactions with international vendors may be exposed to heightened risks of fraudulent activities and unauthorized access. Unauthorized access to the user's payment credentials may lead to fraudulent purchases and compromise the user's digital security. Moreover, without stringent authentication measures in place, the user's financial assets may be vulnerable to exploitation by malicious actors.

It may be desirable to provide innovative solutions that enhance the security of international online transactions.

### SUMMARY OF THE DISCLOSURE

It is an object of this invention to provide a system and method for dynamically selecting an electronic device and an authentication method for a user to perform an electronic transaction with a third party.

A system and method in accordance with the present disclosure may be implemented by dynamically selecting a pathway to electronically authenticate a user to enable the user to perform an electronic transaction with a third party. The method may include, in response to the user initiating the electronic transaction, automatically detecting, by a generative AI engine in real time, a plurality of electronic devices of the user that are registered to, and accessible and activatable by the user. The method may include detecting a plurality of authentication methods, each of which is usable at one or more of the plurality of electronic devices. The authentication methods may include different types of authentication methods.

The method may include selecting, by the generative AI engine in real time, an electronic device from the plurality of electronic devices to be used for authentication. The method may include selecting, by the generative AI engine in real time, an authentication method to be used at the selected electronic device by the user from one or more of the plurality of authentication methods that are usable at the selected electronic device. The method may include requesting, by a processor, electronic authentication of the user using the selected electronic device and the selected authorization method that has been selected by the generative AI engine and presented to the user on the selected electronic device. The method may include authorizing, by the processor, the electronic transaction to be performed upon successful user authentication.

The generative AI engine may be configured to select the electronic device and the authentication method to be performed on the electronic device based on a retrieval-augmented fine-tuning model that is trained on historical electronic transactions of the user and security protocols for which the plurality of the electronic devices are configured. The generative AI engine may be configured to select the electronic device and the authentication method to be performed on the electronic device based on a plurality of contextual factors including a current location of the user and device capabilities of the plurality of electronic devices. The electronic transaction may be an international transaction to be performed where the user and the third party are based in different countries or territories. The international transaction may be an international banking transaction. The selected electronic device may correspond to one of the plurality of electronic devices that is closest to the user at a time of selection of the selected electronic device.

The method may include payment, by the processor, to the third party upon successful authentication. The payment may be made using cryptocurrency. The electronic transaction may be recorded on a blockchain.

The security protocols on which the retrieval-augmented fine-tuning model is based may include protocols that reflect a level of security that has been maintained for the historical electronic transactions. The retrieval-augmented fine-tuning model may be trained on user interaction patterns that reflect past user interactions with entities to perform historical electronic transactions.

The plurality of contextual factors may include network connectivity options for connecting the plurality of electronic devices to a network to perform the electronic transaction with the third party. The plurality of authentication methods may include two or more of one-time password (OTP), multi-factor, biometric, voice, token-based authentication methods, or an authenticator app (application). The generative AI engine may be configured to embed in a vector database information about the plurality of electronic devices and the plurality of authentication methods available at the plurality of electronic devices as vectors representing chunks of data that are accessible using vector indices.

The method may include transmitting automated electronic feedback relating to the electronic transaction and the selected electronic device and the selected authentication method to the generative AI engine for training of the retrieval-augmented fine-tuning model.

The generative AI engine may be configured to select the electronic device to be used by the user to conduct the electronic transaction based on which of the plurality of authorization methods are available at one or more of the plurality of electronic devices.

A system and method in accordance with the present disclosure may be implemented for automatically selecting an electronic device and an authentication method for a user to be electronically authenticated in real-time to perform an electronic transaction with a third party on an electronic device. The system may include a generative AI engine that includes a retrieval-augmented fine-tuning model that includes a retrieval-augmented model based on historical electronic transactions that have been performed by users and security protocols used for the historical electronic transactions. The generative AI engine may include a query engine that is configured to, in response to the user initiating the electronic transaction, automatically detect in real time one or more of a plurality of electronic devices that are registered to, and accessible and activatable by the user.

The generative AI engine may be configured to select in real time the electronic device to be used for authentication from the one or more of the plurality of electronic devices of the user based on a plurality of contextual factors including a current location of the user and device capabilities of the plurality of electronic devices. The generative AI engine may be configured to select in real time which authentication method is to be used at the selected electronic device to be performed by the user based on authentication methods that are available at the selected electronic device as determined by the generative AI engine.

The system may include a processor that is configured to request electronic authentication by the user using the selected electronic device and the selected authorization method that has been selected by the generative AI engine and presented to the user on the selected electronic device. The processor may be configured to authorize the electronic transaction to be performed upon successful user authentication.

The security protocols on which the retrieval-augmented fine-tuning model is based may include protocols that reflect security levels used for the historical electronic transactions.

The retrieval-augmented fine-tuning model may be configured to additionally select the electronic device based on user interaction patterns that reflect past user interactions with entities to perform historical electronic transactions.

The generative AI engine may be configured to select the authentication method based on network connectivity options for connecting the plurality of electronic devices to a network to perform the electronic transaction with the third party.

The plurality of types of authentication methods may include two or more of one-time password (OTP), multi-factor, biometric, voice, token-based authentication methods, or an authenticator app.

The electronic transaction may be an international transaction that is performed where the user and the third party are based in different countries or territories.

The generative AI engine may be configured to embed in a vector database information about the plurality of electronic devices and the plurality of authentication methods available at the plurality of electronic devices. This information could be embedded as vectors representing chunks of data that are accessible using vector indices.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3A shows an illustrative system architecture in accordance with principles of the disclosure.

FIG. 3B shows an illustrative system architecture that may operate in conjunction with the illustrative system architecture shown in FIG. 3A in accordance with principles of the disclosure.

FIG. 4 shows an illustrative example of a process flow diagram for performing an electronic transaction with real time authentication and transaction authorization in accordance with principles of the disclosure.

FIG. 5A shows an illustrative environment in which the process flow may be performed in accordance with principles of the disclosure.

FIG. 5B shows another illustrative environment in which the process flow may be performed in accordance with principles of the disclosure.

FIG. 5C shows yet another illustrative environment in which the process flow may be performed in accordance with principles of the disclosure.

FIG. 6 shows an illustrative flow chart for automatically choosing, using Gen AI, an electronic device for authenticating an electronic transaction and an authentication method to be used in accordance with principles of the disclosure.

### DETAILED DESCRIPTION OF THE DISCLOSURE

An authentication system and method may be provided in which a generative AI engine is leveraged to automatically determine, before authorization of the electronic transaction, which of multiple user electronic devices and which authentication method is to be used to authenticate a user in response to a user initiating payment for the transaction. The system and method may provide a customized authentication pathway for the user to follow for verification of the user.

This system and method is advantageous in that a user does not need to preselect one of the user's electronic devices to use for user authentication. Instead, the system may detect which electronic devices that are registered as belonging to the user are currently accessible to the user. A particular one of the accessible electronic devices that is secure and convenient may be selected by the system to perform the user authentication, without the user preselecting an electronic device for use for authentication. This system and method may be further advantageous to use for authorizing international transactions to be performed online between a user and a third party. The third party may be an international vendor or merchant. International transactions may be transactions where the entities involved in the transaction, such as the payor and payee, may be based in different countries or territories. Payments may be initiated online, at a point of sale device, or otherwise.

The authentication system and method may leverage Generative AI (Gen AI)-based Retrieval-augmented Fine-Tuning Authentication (RAFTA) technology which may be incorporated into a RAFTA Gen AI engine. This technology may combine the strengths of retrieval-augmented based models and fine-tuning strategies along with Gen AI techniques to optimize authentication processes and enhance security.

The Gen AI technique may be used with the RAFTA technology to automatically select an electronic device at which authentication may be performed and to select an authentication mechanism that may be optimally used at the selected electronic device for a particular international online transaction. The automated selection of the device and authorization method may use a Gen-AI-based dynamic channel prediction mechanism that may be generated based on the RAFTA model.

Initially, using this mechanism, retrieval augmentation (RA) may be performed by training a retrieval-augmented language model using a vast and diverse data set encompassing various facets of banking and financial operations. The data set may include data that is already stored at a financial institution where the financial institution operates the RAFTA technology. The data set may include a corpus of information. The corpus of information may include transaction histories that include a history of past transactions, such as types of transactions, parties involved, dates, and payment method. The corpus of information may include security protocols that are available and that may have been used in the past, such as encryption or other access controls. The corpus of information may include user interaction patterns, such as user interactions for users in general who perform such electronic transactions or user interactions with authentication systems. The information in the data set may include data for the current user who is conducting a transaction, including a history of transactions that reflect how a user has interacted in the past with a third party or an authentication system, security protocols that the user may have encountered, and user interaction patterns for the user. Through this training phase, the model learns to effectively retrieve and assimilate relevant information from the knowledge base in the data set during the authentication process. As a retrieval-augmented model, the model may retrieve additional data on which the model has not been trained to augment the model for a particular task.

Following the training phase of the retrieval augmentation, the retrieval-augmented model may be fine-tuned (FT) using task specific data curated for a wide array of scenarios and challenges commonly encountered in cross border financial interactions to generate the RAFTA model. The model may be fine-tuned, for example, by employing predictive modeling techniques that optimize how to select which electronic device and authentication method to use in a particular scenario.

Upon a user initiating an international transaction to be performed electronically, by employing predictive modeling techniques using the RAFTA model, the RAFTA Gen AI engine model may analyze various parameters such as the user's location, available network connectivity options (e.g., Wi-Fi, Bluetooth) at the user's location, and the array of electronic devices, such as smart devices, at the user's disposal while at this location. The model may analyze an IP address of the network that is used. Examples of smart devices include smartphones, laptops, smartwatches, smart glasses, smart rings, home assistant devices, or Internet of Things (IoT) devices. The electronic devices that may be considered at the user's disposal may be electronic devices that are registered to, accessible by, and are currently activated or activatable by the user at this location.

The comprehensive analysis based on the RAFTA model may enable the system to intelligently predict the most suitable mode of authentication or authorization that is personalized to the user for the specific transaction context. The RAFTA Gen AI engine may also balance security concerns against user convenience at to the electronic device to be used. The personalized pathway that is generated for user authentication may be based on a dynamic channel prediction for authentication. The prediction may be dynamic so that if a user changes location, a different pathway for authentication may be selected by the model. Or the pathway may change, such as based on a movement of one or more of the smart devices or based on a change in smart devices that are present at the new location.

The initiation of the payment may activate the authentication process. For example, a use of a credit card or some other type of payment to pay for a transaction, may trigger the authentication process.

For instance, if a user attempts to complete an electronic transaction while commuting in their vehicle that is equipped with network connectivity features, the RAFTA Gen AI engine may recognize the user's mobile device connectivity in their vehicle and predict an authentication pathway that leverages vehicle connectivity for authentication. Vehicle-to-device communication protocols may be used to establish secure authentication, ensuring seamless and safe transactions while on the move.

As another example, if the user conducts a transaction from the comfort of their smart home environment, surrounded by various IoT (Internet of things) devices, the predictive Gen AI system may leverage the array of smart devices within the home network and may recommend authentication methods that may capitalize on the user's domestic ecosystem.

Users may employ one or more virtual agents which they may use on different electronic devices. One such virtual agent is a user avatar that may operate in the metaverse and be authorized by the RAFTA Gen AI engine for user authentication for an electronic transaction. The authorization may be for use of the avatar for authentication at any accessible user electronic device or at a specified user electronic device. Similarly, an NFT that is associated with a user may be authorized by the RAFTA Gen AI engine used to perform authentication.

A system and method in accordance with principles of the disclosure may include the following features:

Integration of RAFTA technology: Both the retrieval-based model and fine-tuning strategies that may be specifically tailored for contextual authentication may be combined. This fusion of methodologies may enable the system to leverage the strengths of both the retrieval-augmented model and the fine tuning strategies to result in enhanced performance and adaptability.

Context-Aware (User) Authentication: Rather than traditional authentication systems that rely on static protocols, the authentication may use a context-aware approach to user verification. The optimal authentication channel may be dynamically predicted based on a multitude of contextual factors such as user location, connectivity options, and device capabilities. This system may provide a personalized and tailored authentication experience for each transaction. This level of granularity and adaptability may obtain a surprising, and unexpected, improvement in online banking security.

Adaptive Learning and Optimization: The system may continuously learn and get optimized over time. Through real-time monitoring and feedback mechanisms, the RAFTA-based Gen AI authentication system may refine its predictive models and authentication strategies to adapt to evolving user behaviors and emerging threats. This iterative learning process may ensure that the system remains proactive and responsive staying ahead of potential security risks and enhancing its effectiveness over time.

Enhanced Security and Convenience: The system may strike a balance between security and convenience to offer users a seamless authentication experience.

Illustrative embodiments of methods, systems, and apparatus in accordance with the principles of the invention will now be described with reference to the accompanying drawings, which form a part hereof. It is to be understood that other embodiments may be used, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The methods, apparatus, computer program products, and systems described herein are illustrative and may involve some or all the steps of the illustrative methods and/or some or all of the features of the illustrative system or apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

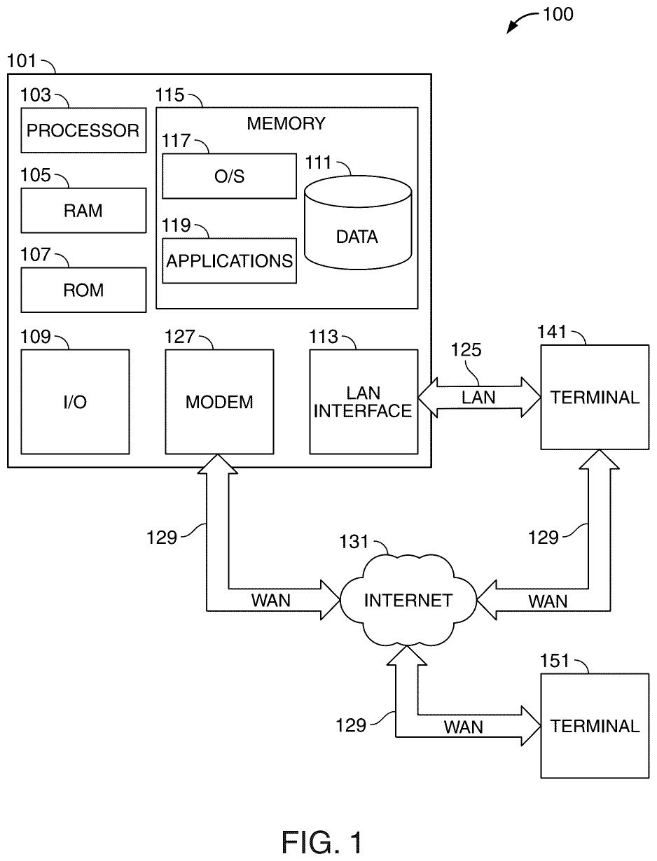

FIG. 1 shows an illustrative block diagram of system 100 that includes computer 101. Computer 101 may alternatively be referred to herein as an “engine,” “server” or a “computing device.” Computer 101 may be any computing device described herein, such as the computing devices running on a computer, smart phones, smart cars, smart cards, and any other mobile device described herein. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all the elements described above relative to computer 101.

In some embodiments, computer 101 and/or Terminals 141 and 151 may be any of mobile devices that may be in electronic communication with consumer device 106 via LAN, WAN, or any other suitable short-range communication when a network connection may not be established.

When used in a LAN networking environment, computer 101 is connected to LAN 125 through a LAN interface 113 or an adapter. When used in a WAN networking environment, computer 101 may include a communications device, such as modem 127 or other means, for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC (Near Field Communication), ZigBee, or any other suitable personal area network.

It will be appreciated that the network connections shown are illustrative and other means of establishing a communications link between computers may be used. The existence of various well-known protocols such as TCP/IP, Ethernet, NFT, HTTP, and the like is presumed, and the system can be operated in a client-server configuration to permit retrieval of data from a web-based server or API (Application Programming Interface). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may use one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may use the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

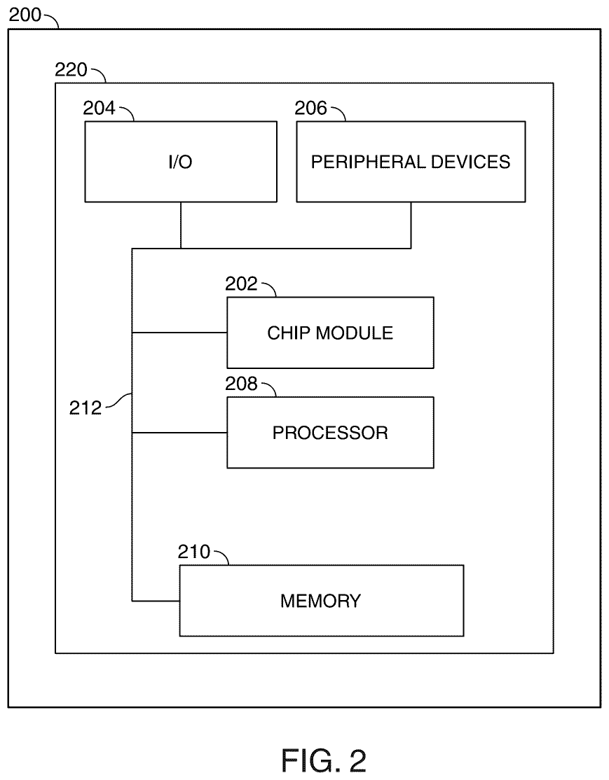

FIG. 2 shows illustrative apparatus 200, which may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY level hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

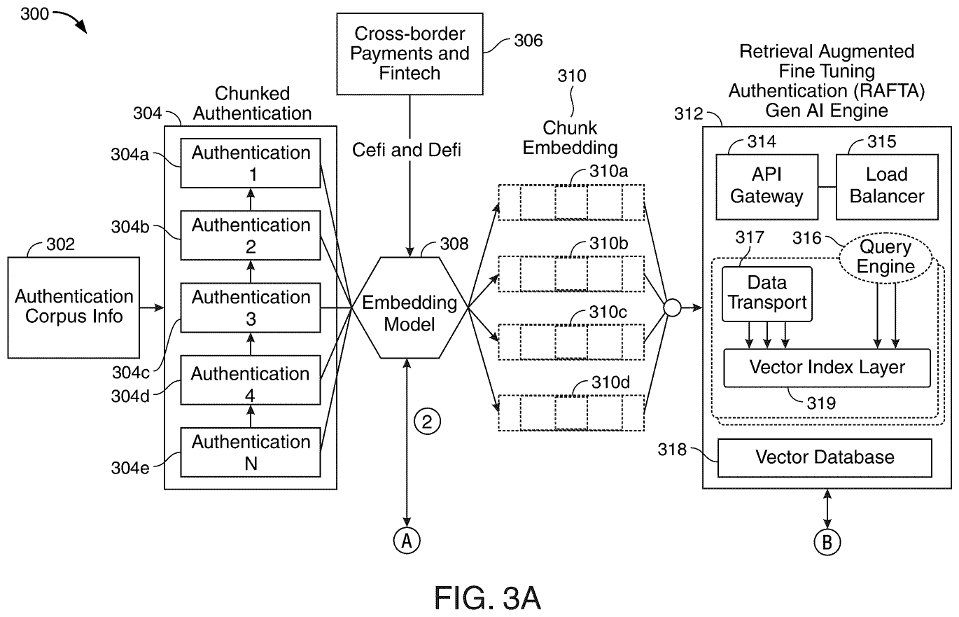

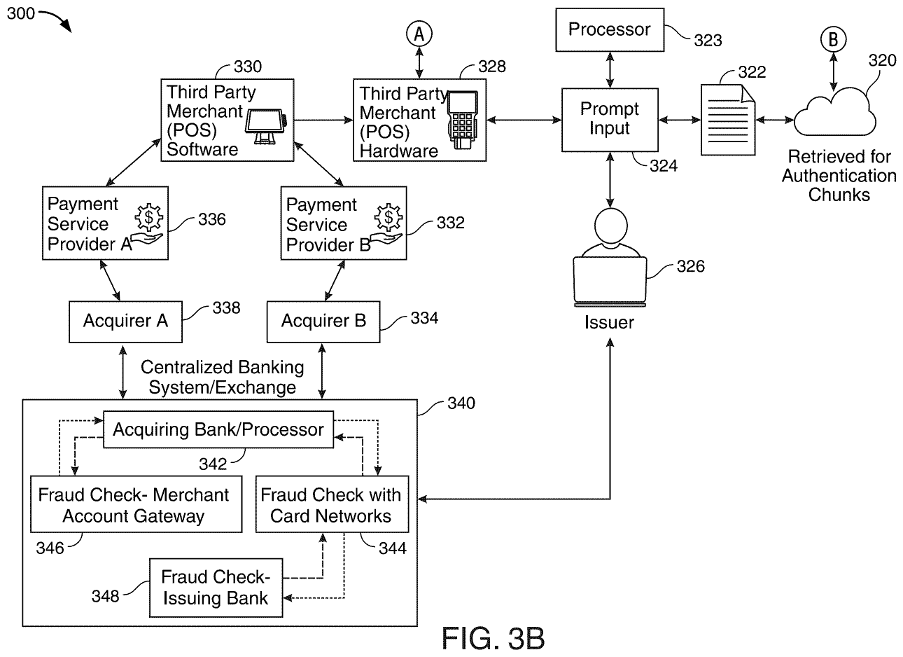

FIGS. 3A and 3B show an illustrative system architecture which may be used to provide a system 300 in accordance with principles of the disclosure. System 300 may be used to select an electronic device at which a user may be authenticated for the user to authorize an electronic transaction to proceed and payment to be made. The electronic transaction may be performed in real time. The electronic transaction may be an international transaction that is performed online by a user of the electronic device and a third party. The user and third party may be located or may operate in different countries or territories. The different countries or territories may have different types of authentication methods that are technologically available, reliable, or permitted. For example, one country may allow for secure texting of an OTP to be transmitted for authentication, while another country may not allow texting an OTP to a party in a different country so that another type of authentication may be considered. The different countries or territories may have different laws that indicate what types of authentication are permitted.

As shown in FIG. 3A, in system 300, a data set may include an authentication corpus of information 302 that may be compiled to train a RAFTA Gen AI engine 312. Corpus of information 302 may include several types of information, including data already maintained by a financial institution. The data may include transaction histories that include a history of past transactions, security protocols that are available and that may have been used in the past, and user interaction patterns that have been used for user interactions with an authentication system. The RAFTA Gen AI engine 312 may be leveraged to determine a selected authentication method to be used to authenticate and authorize an electronic transaction on a particular electronic device, without the user preselecting one of the plurality of electronic devices for use for authentication.

Included within corpus 302 may be information about different authentication methods. For easier searching, the authentication methods may be stored as chunked authentication 304 methods, with different authentication methods separately stored as separate chunks. For example, five different authentication methods 304a, 304b, 304c, 304d, and 304e are shown in FIG. 3A. The chunked authentication methods 304 and other information from corpus information 302 may be used for training embedding model 308.

Cross-border payments and financial technology (fintech) information 306 may also be fed to embedding model 308. Information 306 may include cross-border payments, such as data from payments that have been made and information about financial technology (fintech), such as technology that has been used in past electronic transactions, such as cross-border transactions. Embedding model 308 may encode the information that it has obtained by chunk embedding to generate embedded chunks 310 that organizes data into separately embedded chunks, such as embedded chunks 310a, 310b, 310c, 310d, for storage as vectors that may be retrievable and processable as a unit.

The embedded chunks 310 may be fed to RAFTA Gen AI engine 312. RAFTA Gen AI engine 312 may include an application programming interfaces (API) Gateway 314 to enable data exchange with other computers, such as user electronic devices, a load balancer 315 that may be used to balance a load across components, and a query engine 317. Query engine 316 may be used to search for data to be used by RAFTA Gen AI engine 312 to determine electronic devices belonging to a user and available authentication methods at the user's devices. This information may be used by the Gen AI engine to select the optimal device and authentication method at that electronic device for automatically performing an electronic transaction in real time, which may be a cross-border transaction, requested by a user. Data may be transported as vectors and stored in a vector database 318. The vectors may be indexed in a vector index layer 319. Query engine 316 may retrieve the data from vector database 318 as vectors using vector index layer 319. Vector database 318 may be database in an AI platform for Gen AI engine 312. Examples of a vector database that may be used include a vector database, such as a vector database from Pinecone, Qdrant, Redis, or Weaviate. The vector database 318 may be operated by the entity operating Gen AI engine 312, which entity may be a financial institution.

FIG. 3B shows further illustrative system architecture that may operate in conjunction with system architecture shown in FIG. 3A. A user may initiate an electronic transaction using a banking interface on a user electronic device in response to a prompt input 324. Prompt input 324 may appear on a user computer or smart device that may access a third party's hardware or web site. The third party may be a merchant of goods or services. The Gen AI engine 312 may be accessed via network 320, such as the Internet, and provided with certain details related to the proposed transaction, such as countries of the parties to the transaction or information relating to authentication methods that may be permitted (e.g., contractually) for the transaction. The Gen AI engine 312 may detect the electronic devices that are registered to, and accessible and activatable by the user, and authentication methods that are available on the accessible devices. Authentication methods that are available may include, for example, one-time password (OTP), multi-factor, biometric, voice, or token-based authentication or other forms of electronic authentication, such as an authenticator app. In embodiments, system 300 may be used to select a virtual user representation, such as an avatar or NFT, to be used at an electronic device to be used for authentication and authorization.

The devices that are accessible to the user may be determined based on detected movement of the device, like a smartphone or smart watch, at a current location and may be confirmed based on other information such as Global Positioning System (GPS) and triangulation. The detection may be made by sending a query from query engine 316 to vector database 318 and possibly to other data sources in real time, such as by pinging other known electronic devices that are registered to the user to determine whether they are currently accessible. The electronic devices may use wireless connections, such as mobile network or Wi-fi communications, to communicate with Gen AI engine 312 over the Internet 320. The electronic device selected by Gen AI engine 312 for the user to use for authentication may be the same as the device used to initiate the transaction or may be a different device that the user is instructed by the Gen AI engine to use for authentication.

Once the electronic device to be used for authentication is specified, the authentication device may receive an authentication chunk from the vector database. The authentication chunk may specify the method of authentication to be used, such as the most secure authentication method or past user preference or both, or may offer the user more than one authentication methods with which a user may be authenticated. The authentication for certain transactions may require multiple authentications, with more than one authentication method, required to be performed.

The user may have different devices that may be available to the user at a given time within the context in which the user finds oneself. Examples of different contexts include a vehicle, a home IoT network, or at a gym outside of the user's home. The registered electronic devices may be the vehicle itself or devices located in or near the vehicle, or devices located in the user's home or gym.

The electronic transaction may be initiated using different forms of payments. For example, monies may be transferred electronically between bank accounts in a particular currency. Credit cards may be accepted. Cryptocurrency may be used. The cryptocurrency may be a cryptocurrency that is stored in a centralized exchange (cefi) or a cryptocurrency that is used in a decentralized manner (defi).

POS hardware 328 may access third party/merchant software 330 to access a payment service provider. The payment service provider may be selected from multiple payment service providers 332, 336. Each payment service provider may be associated with a different acquirer 334, 338 to collect payment. Acquirer A 338 or acquirer B 334 may interact with a centralized banking system or exchange 340 where a centralized banking system or exchange is used for payment. When paying with cryptocurrency in a decentralized cryptocurrency exchange, there may not be a payment service provider and there may be no centralized banking system or exchange. Instead, smart contracts may be used instead to govern the transaction.

Before proceeding with the requested transaction, prompt input 324 may request that the user perform at 322 an authentication method as specified RAFTA Gen AI engine 312 and retrieved as an authentication chunk over network 320. User may perform the requested authentication using prompt input 324.

In the case where there is a centralized banking system or exchange, centralized banking system or exchange 340 may include an acquiring bank 342 which may be configured to have a processor that processes payments that center centralized banking system/exchange 340. Acquiring bank processor 342 may perform a fraud check. Payment may be made with a credit card from one of the card networks 344, such as a credit or debit card network, that has been presented used for payment. The fraud check with card networks 344 may communicate with the issuing bank 348 of the card to be used to perform the fraud check. Acquiring bank 342 may further perform a fraud check for merchant account gateway 346. Merchant account gateway 346 may be, for example, a global payment platform. If the acquisition passes the fraud check with the card networks and the merchant account gateway and the user authentication is successful, acquiring bank 342 may interact with issuer for issuer 326 to complete payment for the electronic transaction.

Gen AI engine 312 may monitor and log whether the electronic transaction request, using the user electronic device and authentication method that was selected by the Gen AI engine, and the authentication was successful for the user, or whether fraud was detected. This information may provide feedback to the predictive model via third party/merchant hardware 328 or otherwise to refine the predictive models and authentication strategies of the authentication system to adapt to evolving user behaviors and emerging threats.

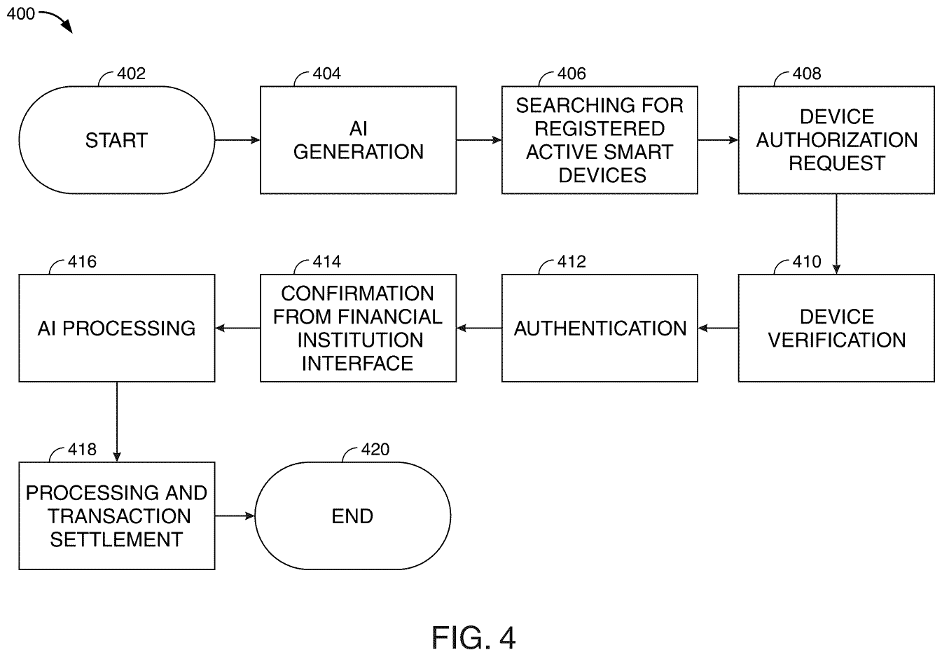

FIG. 4 shows an illustrative process flow 400 that may be implemented to conduct a cross-border (international) transaction in accordance with principles of the disclosure.

Process flow 400 starts at step 402, where the user may initiate an international transaction through a banking interface. The transaction may be initiated online. At step 404, a Gen AI engine may use AI to process the request and generate a personalized transaction pathway that may be personalized as to which electronic device to use to further conduct the transaction and what authentication method is to be used. At step 406, Gen AI engine may cause a search to be conducted for active smart devices registered to and accessible by the user in the vicinity of the user at the time of authentication. At step 408, the banking system may issue a device authorization request that prompts the user to authorize the electronic transaction through a selected user device that may be selected by the Gen AI engine. The user may receive a notification on the selected user device. At step 410, the user may be prompted to verify that the user has possession of the device.

At step 412, after device verification, the user may be prompted to authenticate the user using an authentication method that is suitable to the device, the location in which it is located, and the transaction. The authentication may require that the user “sign” the transaction using one or more cryptographic keys or digital certificates. The authentication may be location-based, such as based on the location of one or both of the parties to the electronic transaction. Following a successful user authentication, at step 414, the user may receive a confirmation of the transaction from a financial institution, such as on a financial institution interface. At step 416, AI may be used to process the transaction, including processing for accuracy and compliance.

At step 418, the system may process and settle the transaction using an electronic payment. The electronic payment may be conducted, for example, as a debit or credit card payment, a wire transfer, or with cryptocurrency. If cryptocurrency is used, the transaction details may be recorded on a blockchain, and the transaction may be governed by smart contracts. At step 420, the process flow may end.

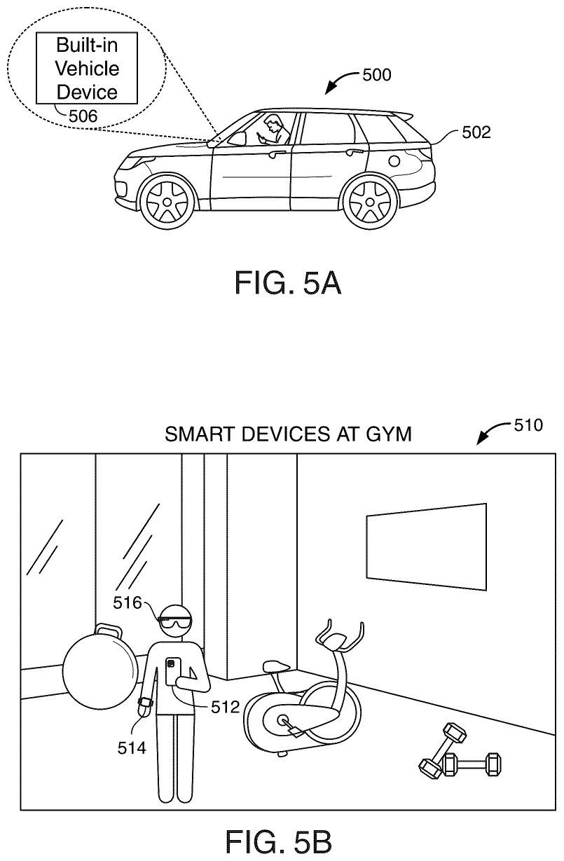

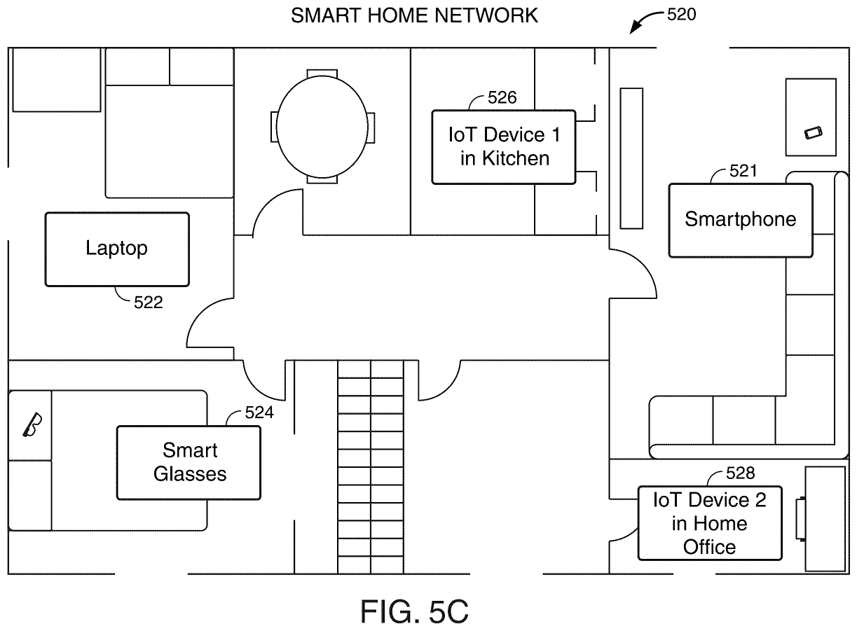

FIG. 5A shows an illustrative environment 500 in which an electronic transaction may be conducted by a user 501 while situated in or near a vehicle 502 when the user performs an electronic transaction. User 501 may have a smartphone 504 while in the vehicle and may also have a built-in vehicle smart device 506, such as a built-in tablet or infotainment system. Smartphone 504 and built-in vehicle smart device 506 may be wirelessly connected to a network, such as the Internet, with a mobile communication system. Both electronic devices 504, 506 may be registered to the user in a database of a financial institution. The RAFTA Gen AI engine may detect that devices 504 and 506 are registered to and currently accessible by the user, such as by retrieving the most current device information from the database of the financial institution. The Gen AI engine may select which of devices 504 and 506 is more optimal to perform the electronic transaction, and may select one or more authentication method to provide to the user on the selected electronic device. A factor that the RAFTA Gen AI engine may use in choosing a device may be whether a particular authentication method is available on one device and not the other. A factor that the RAFTA Gen AI engine may use in choosing a device may be the safest device to use, such as if the vehicle is in motion, built-in vehicle smart device 506 may be preferred for use. The RAFTA Gen AI engine may also select the authentication method to be used. Upon the user entering the requested user authentication at the RAFTA Gen AI-selected device, the transaction may be performed.

FIG. 5B shows another illustrative environment 510 in which an electronic transaction may be conducted by a user in accordance with the present disclosure. In this environment, a user may have various electronic devices, including a smart phone 512, a smart watch 514, and smart glasses 516 that are registered and accessible by the user. The electronic devices may be wirelessly connected to a network, such as the Internet, with a mobile communication system or with Wi-Fi. The RAFTA Gen AI engine may also select which device is optimal for the user to perform the electronic transaction. The RAFTA Gen AI engine may select the electronic device and an authentication method to be used for user authentication on the selected device based on one or more criteria that the RAFTA Gen AI engine determines to be appropriate. The device that is selected by the RAFTA Gen AI engine for authentication may be the device that is closest to the user at the time of device selection if it has an adequately secure authentication function. The device by the RAFTA Gen AI engine may be a different device if the closest device does not provide as secure or safe authentication. The device selected by the RAFTA Gen AI engine for authentication may be selected based on the device that has a quickest wireless connection.

FIG. 5C shows an illustrative environment 520 in which an environment in which the transaction may be conducted where the environment is a smart home network in which smart devices may communicate with one another. The illustrated network may include electronic devices such as a smartphone 521, a laptop 522, smart glasses 524, and Internet of Things (IoT) devices 526, 528. The electronic devices may be wirelessly connected to the Internet, such as with a mobile communication system or Wi-Fi. The RAFTA Gen AI engine may select which device is optimal for the user to perform the electronic transaction and may select one or more authentication methods that the engine specifies that the user perform for user authentication on the auto selected device.

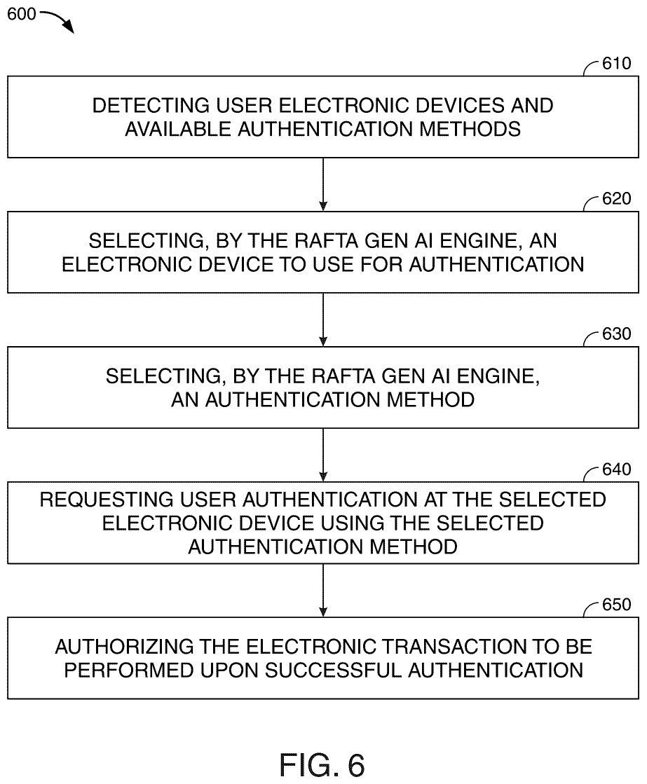

FIG. 6 shows an illustrative flow chart 600 with steps that may be implemented in accordance with principles of the disclosure to determine a user-personalized, context adaptive pathway for a user to be authenticated for performing an electronic transaction.

At step 610, the RAFTA Gen AI engine may detect accessible user electronic devices and authentication methods available at the electronic devices. At step 620, the RAFTA Gen AI engine may select an electronic device for the user to perform authentication. At step 630, the RAFTA Gen AI engine may select an authentication method to be performed at the selected electronic device. At step 640, when an electronic transaction is initiated, the user may be requested to perform the authentication at the selected electronic device using the selected authentication method. At step 650, upon successful authentication, the electronic transaction may be performed.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for leveraging a predictive model for a RAFTA Gen AI model for enhanced authentication for international transactions may be provided. Persons skilled in the art will appreciate that the present invention can be practiced by other than the described embodiments, which are presented for purposes of illustration rather than of limitation.

What is claimed is:

1. A method for dynamically selecting a pathway for a user to be electronically authenticated to enable performance of an electronic transaction with a third party, the method comprising:
in response to the user initiating the electronic transaction, automatically detecting, by a generative AI engine in real time, a plurality of electronic devices of the user that are registered to, and accessible and activatable by the user, and detecting a plurality of authentication methods that are usable at one or more of the plurality of electronic devices;
selecting, by the generative AI engine in real time, an electronic device from the plurality of electronic devices to be used for authentication;
selecting, by the generative AI engine in real time, an authentication method to be used at the selected electronic device by the user from one or more of the plurality of authentication methods that are usable at the selected electronic device;
requesting, by a processor, electronic authentication of the user using the selected electronic device and the selected authorization method that has been selected by the generative AI engine and presented to the user on the selected electronic device; and
authorizing, by the processor, the electronic transaction to be performed upon successful user authentication;
wherein the generative AI engine is configured to select the electronic device and the authentication method to be performed on the electronic device based on:
a retrieval-augmented fine-tuning model that is trained on historical electronic transactions of the user and security protocols for which the plurality of the electronic devices are configured; and
a plurality of contextual factors including a current location of the user and device capabilities of the plurality of electronic devices.

2. The method of claim 1, wherein the security protocols on which the retrieval-augmented fine-tuning model is based comprise protocols that reflect a level of security that has been maintained for the historical electronic transactions.

3. The method of claim 2, wherein the retrieval-augmented fine-tuning model is further trained on user interaction patterns that reflect past user interactions with entities to perform historical electronic transactions.

4. The method of claim 3, wherein the plurality of contextual factors further include network connectivity options for connecting the plurality of electronic devices to a network to perform the electronic transaction with the third party.

5. The method of claim 1, wherein the plurality of authentication methods include two or more of one-time password (OTP), multi-factor, biometric, voice, token-based authentication methods, or an authenticator app.

6. The method of claim 1, wherein the electronic transaction is an international transaction to be performed where the user and the third party are based in different countries or territories.

7. The method of claim 1, wherein the generative AI engine is configured to embed in a vector database information about the plurality of electronic devices and the plurality of authentication methods available at the plurality of electronic devices as vectors representing chunks of data that are accessible using vector indices.

8. The method of claim 1, wherein the selected electronic device corresponds to one of the plurality of electronic devices that is closest to the user at a time of selection of the selected electronic device.

9. The method of claim 1, further comprising payment, by the processor, to the third party upon successful authentication.

10. The method of claim 9, wherein the payment is made using cryptocurrency.

11. The method of claim 9, wherein the electronic transaction is recorded on a blockchain.

12. The method of claim 1, further comprising transmitting automated electronic feedback relating to the electronic transaction and the selected electronic device and the selected authentication method to the generative AI engine for training of the retrieval-augmented fine-tuning model.

13. The method of claim 1, wherein the generative AI engine is further configured to select the electronic device to be used by the user to conduct the electronic transaction based on which of the plurality of authorization methods are available at one or more of the plurality of electronic devices.

14. A system for automatically selecting an electronic device and an authentication method for a user to be electronically authenticated in real-time to perform an electronic transaction with a third party on an electronic device, the system comprising:
a generative AI engine that comprises:
a retrieval-augmented fine-tuning model that includes a retrieval-augmented model based on historical electronic transactions that have been performed by users and security protocols used for the historical electronic transactions; and
a query engine that is configured to, in response to the user initiating the electronic transaction, automatically detect in real time one or more of a plurality of electronic devices of the user that are registered to, and accessible and activatable by the user; and
that is configured to:
select in real time the electronic device to be used for authentication from the one or more of the plurality of electronic devices of the user based on a plurality of contextual factors including a current location of the user and device capabilities of the plurality of electronic devices; and
select in real time which authentication method is to be used at the selected electronic device to be performed by the user based on authentication methods that are available at the selected electronic device as determined by the generative AI engine; and
a processor that is configured to:
request electronic authentication by the user using the selected electronic device and the selected authorization method that has been selected by the generative AI engine and presented to the user on the selected electronic device; and
authorize the electronic transaction to be performed upon successful user authentication.

15. The system of claim 14, wherein the security protocols on which the retrieval-augmented fine-tuning model is based comprise protocols that reflect security levels used for the historical electronic transactions.

16. The system of claim 15, wherein the retrieval-augmented fine-tuning model is further configured to additionally select the electronic device based on user interaction patterns that reflect past user interactions with entities to perform historical electronic transactions.

17. The system of claim 16, wherein the generative AI engine is further configured to select the authentication method based on network connectivity options for connecting the plurality of electronic devices to a network to perform the electronic transaction with the third party.

18. The system of claim 14, wherein the plurality of types of authentication methods include two or more of one-time password (OTP), multi-factor, biometric, voice, token-based authentication methods, or an authenticator app.

19. The system of claim 14, wherein the electronic transaction is an international transaction to be performed where the user and the third party are based in different countries or territories.

20. The system of claim 14, wherein the generative AI engine is configured to embed in a vector database information about the plurality of electronic devices and the plurality of authentication methods available at the plurality of electronic devices as vectors representing chunks of data that are accessible using vector indices.
